(19) United States
(12) Patent Application Publication
(10) Pub. No.: US 2015/0126236 A1
(43) Pub. Date: May 7, 2015

(54) CONTROLLING INTERFERENCE CAUSED BY SECONDARY SYSTEMS

(71) Applicants: Amitav Mukherjee, Santa Clara, CA (US); Ari Hottinen, Espoo (FI)

(72) Inventors: Amitav Mukherjee, Santa Clara, CA (US); Ari Hottinen, Espoo (FI)

(73) Assignee: Nokia Corporation, Espoo (FI)

(21) Appl. No.: 14/358,327

(22) PCT Filed: Nov. 25, 2011
(86) PCT No.: PCT/FI2011/051044

§ 371 Date: Jul. 25, 2014

(51) Int. Cl. H04W 16/14; H04W 72/04; H04W 52/38

(52) U.S. Cl. CPC H04W 16/14; H04W 52/38; H04W 72/0453
USPC 455/522

(57) ABSTRACT

There is provided a method comprising: obtaining, at a base station of a secondary user system utilizing shared radio communication resources with a coexisting primary user system, channel state information with respect to both a propagation channel between the secondary user and the base station and a propagation channel between the secondary user and a primary user; jointly determining power allocation and transmit coefficients for at least one data stream which is to be transmitted from the secondary user to the base station; and causing communication of information indicating the determined power allocation and transmit coefficients to the secondary user.

### FIELD

The invention relates generally to mobile communication networks. More particularly, the invention relates to a mobile communication network where a secondary system shares radio resources with a primary system.

### BACKGROUND

Modern wireless telecommunication systems aim to efficient utilization of the available frequency spectrum so as to maximize capacity and throughput. Multiple systems or sub-systems (underlay systems) may even be allocated to share a common frequency band. However, the operation of so-called secondary systems operating on the shared resources with primary systems needs to be controlled such that the interference from network elements of the secondary systems do not interfere the operation of the primary system.

### BRIEF DESCRIPTION OF THE INVENTION

Embodiments of the invention seek to improve the efficiency of a network comprising a primary system and a secondary system sharing common resources.

According to an aspect of the invention, there are provided methods as specified in claims 1 and 13.

According to an aspect of the invention, there are provided apparatuses as specified in claims 18, 30 and 35.

According to an aspect of the invention, there is provided a computer program product as specified in claim 36.

According to an aspect of the invention, there is provided an apparatus comprising means configured to perform any of the embodiments as described in the appended claims.

Embodiments of the invention are defined in the dependent claims.

### LIST OF DRAWINGS

In the following, the invention will be described in greater detail with reference to the embodiments and the accompanying drawings, in which

FIGS. 1A and 1B present a communication scenario and related example radio resource usage, respectively;

FIG. 2 shows a secondary user communicating with a secondary base station and causing interference to a primary user;

FIGS. 3 and 4 show methods according to some embodiments;

FIGS. 5 and 6 present apparatuses according to some embodiments;

FIG. 7 depicts signaling flow diagram according to an embodiment; and

FIG. 8 presents some simulation results.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

The scarcity of unoccupied radio spectrum is usually the bottleneck in high-speed wireless cellular and data networks. Cognitive radio is a rapidly emerging concept that seeks to improve spectral efficiency by allowing multiple radios to operate simultaneously in the same spectrum at the same geographic location. In such underlay systems with full frequency reuse, it is critical for the cognitive or secondary users (SUs) to limit the interference caused to incumbent or primary users (PUs) that are the licensed owners of the spectrum. Examples of underlay systems are device-to-device (D2D) networks coexisting with a cellular network, heterogeneous networks (HetNet) cells, such as femto- or picocells) that operate under the frequency reuse condition, and unlicensed users that operate in TV White Space spectrum (e.g., IEEE 802.22).

As said, the primary users of a primary system having a license to utilize the frequency may require seamless data transmission. For example, the TV broadcasters may need to have their transmission substantially free of interference. There are also other primary systems, such as wireless micro-phones, elements facilitating public safety, etc., which may require interference-free operation. However, when the frequency available for the primary users is not fully in use, the spectrum may be opportunistically used by the secondary users for wireless broadband data transmission, for example, without imposing severe interference to the licensed, primary users. There may be a database or an authorized shared access (ASA) approach applied when the secondary users aim in applying the common resources.

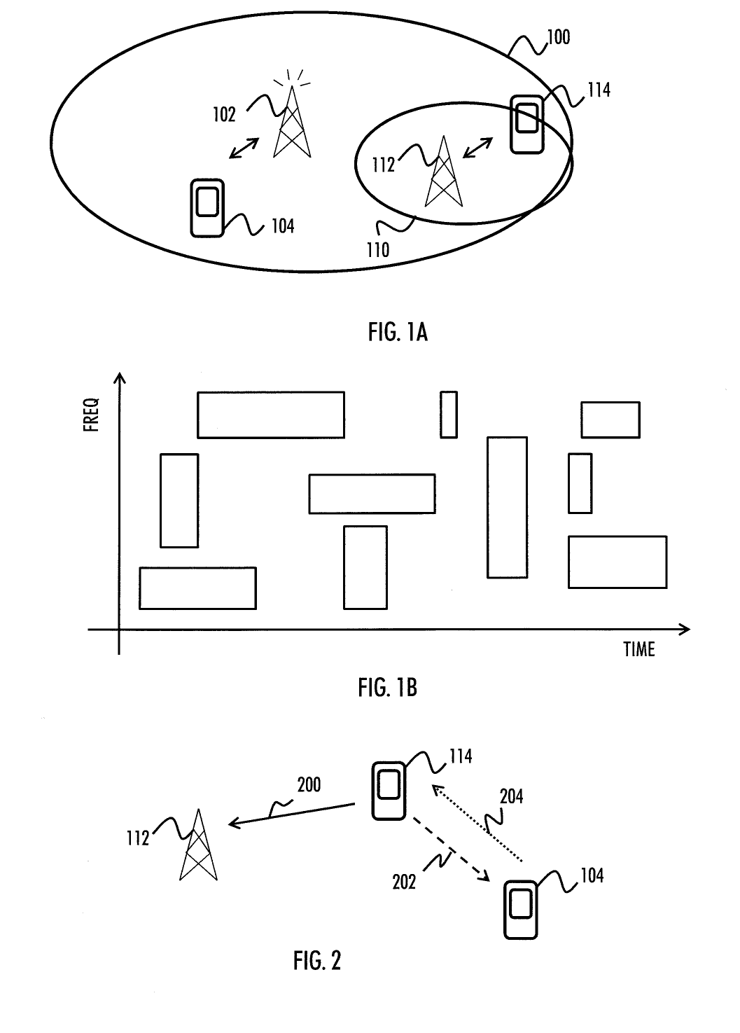

A general communication scenario to which embodiments of the present invention may be applied is illustrated in FIG. 1A. Referring to FIG. 1A, at least two systems are located such that their coverage areas overlap at least partly and that they may be configured to operate on a common frequency band. For example, a first system may be a cellular network or a television (TV) broadcast system. Let us assume that the first, primary system is a cellular network comprising a cellular base station 102 communicating with primary user terminals 104 on some channels of the common frequency band in a certain geographically limited area 100. The cellular network may operate for example according to at least one of the following radio access technologies (RATs): Global System for Mobile communications (GSM, 2G), GSM EDGE radio access Network (GERAN), General Packet Radio Service (GRPS), Universal Mobile Telecommunication System (UMTS, 3G) based on basic wide-band-code division multiple access (W-CDMA), high-speed packet access (HSPA), Long Term Evolution (LTE) and/or the LTE-Advanced (LTE-A) of the 3^{rd} Generation Partnership Project (3GPP). In general, the first system may be any other system having a frequency band that may be shared with a second system and that may become fragmented through the frequency utilization of the first system.

The second system, which may be called a secondary system, a secondary user system or a system for users without priority with respect to frequency band, may be, for example, an ad-hoc D2D communication system where users communicate directly with each other, a broadband communication system, such as the worldwide Interoperability for Microwave Access (Wi-MAX), IEEE 802.11-based network (e.g. IEEE 802.11n, 802.11af, or 802.11ac), or IEEE 802.22-based network. The secondary system may comprise a network element 112 as an access point, such as a secondary base station providing radio coverage to a cell 110 and providing a client station 114 (i.e. a secondary user, which may be also called a terminal device, user equipment (UE) or a mobile station) with uni- or bidirectional wireless communication services. The secondary system may also utilize frequency channels on the common frequency band. For the sake of clarity, however, let us assume that the first system (primary user system) is a cellular system with a plurality of primary users (PU) 104 and a primary user base station (PBS) 102, and the second system (secondary user system) is a broadband communication system comprising a plurality of secondary users (SU) 114 and a secondary user base station (SBS) 112. The PBS may be, for example, a radio network controller (RNC), an evolved node B (eNB), or any other apparatus capable of controlling radio communication and managing radio resources within the cell 100.

It may be assumed that the first system is a primary system or a primary user system having a priority over the frequency bands. The secondary system may then be configured to dynamically adapt to the spectrum utilization of the primary system and occupy a frequency band not used by the primary system in a given geographical area. As shown in FIG. 1B, spectrum utilization by the primary users may be fragmented in both time and frequency. The irregular spectrum occupation is illustrated by the boxes in FIG. 1B. It can be deduced from FIG. 1B, that there may be opportunities for the secondary users to utilize the resources without interfering the primary users. However, it may also be possible by the secondary users to occupy some of the already in-use spectrum assuming the secondary user do so with appropriate communication parameters. In other words, when, how and what to transmit and/or receive by the SUs may determine the interference caused to the primary system.

In order to further aid interference mitigation, it is proposed to utilize the degrees of freedom (spatial, code, frequency, etc.) that are available at the SUs. Therefore it is proposed to jointly determine power allocation and transmit coefficients for at least one data stream which is to be transmitted from the at least one SU 114 to the SBS. The transmit coefficients may be applied by the transmitter to affect the data that is to be transmitted. The transmit coefficients may comprise one of the following: spatial multiplexing precoder coefficients to be applied in multistream transmission from the at least one SU 114 to the SBS 112, spatial beamforming coefficients to be applied in rank one (single stream) transmission from the at least one SU 114 to the SBS 112, and spreading sequence to be applied in rank one transmission from the at least one SU 114 to the SBS 112. Thus, solutions are provided for the design of arbitrary precoding matrices for spatial multiplexing wherein the SUs 114 may transmit several data streams, and for the design of cognitive spatial beamformers and spreading sequences for the SUs 114 wherein the SU may transmit a single stream (i.e. rank 1 channel from the SU to the SBS). The proposed embodiments may thus be applicable to a network comprising multiple SUs simultaneously transmitting to a common destination, such as to the SBS 112, while interfering with at least one primary user. The determination of the precoders/beamformers/spreading sequences may be performed in such a way to mitigate both the intra-SU and SU-to-PU interference without sacrificing performance excessively. Thus, the interference to one or more neighboring secondary and/or primary users operating on the same frequency may be minimized. All network entities may or may not be equipped with multiple antennas. The embodiments may simultaneously provide power allocation for the data streams transmitted from the SU, for example. Further, some embodiments may provide for SUs to select the beamforming/spreading sequences from predefined codebooks while balancing the multiple-access interference on the secondary uplink with the interference caused to the primary network.

In the embodiments, the following system model with Kₛ SUs may be assumed. The received signal at the secondary BS (SBS) 112 as shown in FIG. 2 and at the primary user 104, respectively, may be written as

yₛ=Σᵢ₌₁^{K}^{_{sH}}ᵢxᵢ+nₛ (1)

and

yₚ=Hₚxₚ+Σᵢ₌₁^{K}^{ₛ}Gᵢxᵢ+nₚ (2),

where Hᵢ the spatial propagation channel 200 from SU i 114 to the SBS 112, Hᵢ is the interfering propagation channel 202 from SU i 114 to the PU 104, xᵢ is the SU signal, and xₚ is the PU signal. For convenience of notation, a single primary receiver model is considered, which may be straightforwardly extended to multiple PUs, if required. As said, the embodiments may provide for determination of transmit coefficients, such as multiplexing precoders, beamformers, and spreading sequences. For the first two multi-antenna scenarios (multiplexing precoders and beamformers), assume each SU 114 has Nₜ antennas, the SBS 112 has Nₛ antennas, and the PU 104 has M antennas. Thus, the H and G matrices may in these embodiments be multiple-input multiple-output (MIMO) channel matrices with dimensions Nₛ×Nₜ and M×Nₜ, respectively. In MIMO systems, a transmitter may send multiple streams by multiple transmit antennas. The transmit streams go through a channel which consists of all Nₜ×Nₛ paths between the transmit antennas at the transmitter and receive antennas at the receiver, i.e. at the SBS 112. Then, the receiver may obtain the received signal vectors by the multiple receive antennas and decode the received signal vectors into the original information. However, for the spread-spectrum code division multiple access (CDMA) embodiment, H and G may be lower-triangular Toeplitz matrix representations of the multipath channels of dimension N×N, where N is the spreading factor, assuming the inter-symbol interference is negligible. Finally, background additive zero-mean Gaussian noise vectors are denoted for the SU and the PU by nₛ and nₚ, respectively.

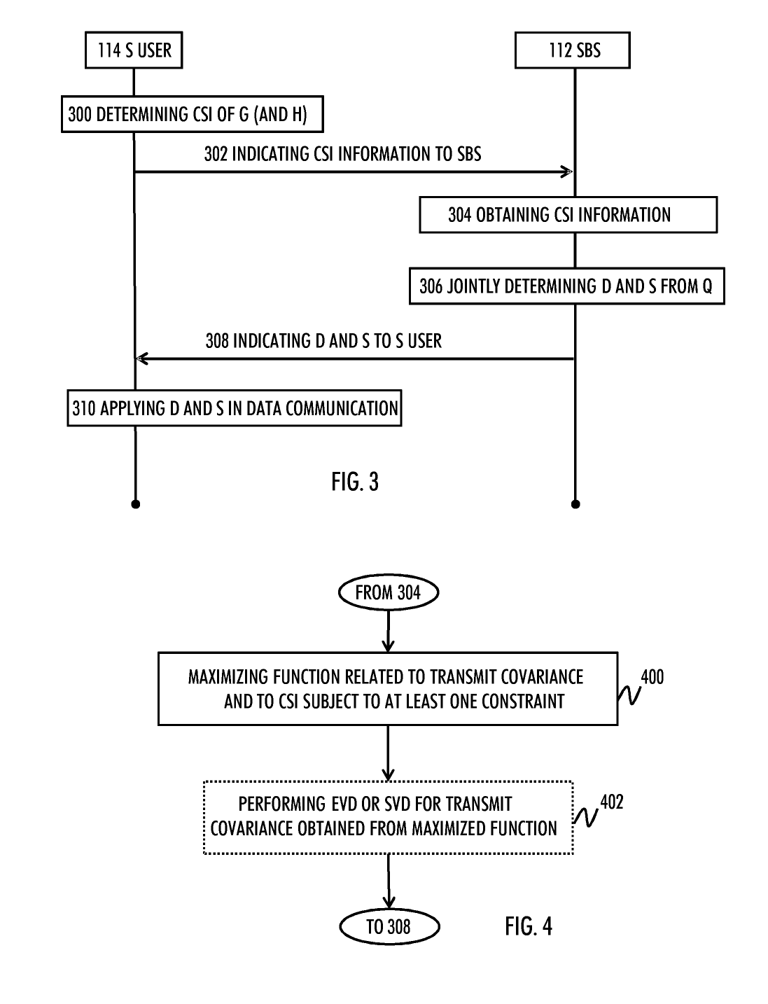

Let us take a look at FIG. 3 which shows a signaling flow diagram between the SU 114 and the SBS 112. In order to allow the SBS 112 to determine the required parameters which balance the quality of service (QoS) of the SU network with the interference caused to the primary network, a complete or near-perfect channel state information (CSI) may need to be known by the SBS 112. Regarding the CSI, the SUs 114 may in step 300 measure at least the interfering channel(s) G from the at least one PU. Although the at last one PU may indicate the CSI to the SU 114 explicitly, no feedback or coordination may be needed from the PUs 104. In the embodiment, the SU 114 may estimate an incoming channel 204 (shown in FIG. 2) from each of the at least one primary user. In a time division duplex (TDD) setup, the SUs 114 may estimate the incoming channel(s) from the at least one PU 104 by using known pilot signals, for example, or by other known means for determining the CSI. Further, the SU 114 may apply a reciprocity assumption in order to derive the interfering channel Gᵢ from the SU 114 to the at least one PU. Similar is applicable in a frequency division duplex (FDD) system, where the SUs 114 may exploit the statistical reciprocity (long-term) of the incoming and outgoing channels to the PU 104 to form a statistical estimate of the channel Gᵢ. In any case, the SU 114 may be capable of obtaining the interfering channel information. The SUs 114 may also be able to determine the CSI for the propagation channel H between the SU 114 and the SBS 112. Alternatively, the determination of the CSI of the channel H may be left to the SBS 112. The SUs 114 may consequently communicate information indicating the determined channel state information, comprising at least the CSI of the at least one G, to the SBS 112 in step 302. In this manner, the SBS 112 may obtain channel state information with respect to G and H in step 304. However, it should be noted that only CSI of G may be obtained from the SU 114 and the CSI of H may be either obtained from the SU 114 or determined at the SBS 112. The SBS 112 may in step 306 be responsible of jointly determining power allocation D and transmit coefficients S, such as the precoding matrices, the beamformer(s), or the spreading sequences, by taking into account the channel state information (CSI). This is advantageous so that the determination of the parameters may be interference-aware. Further, the SBS 112 may afterwards in step 308 indicate the determined parameters D and S to the SUs 114 in order to allow the SUs 114 to perform communication according to the determined parameters in step 310.

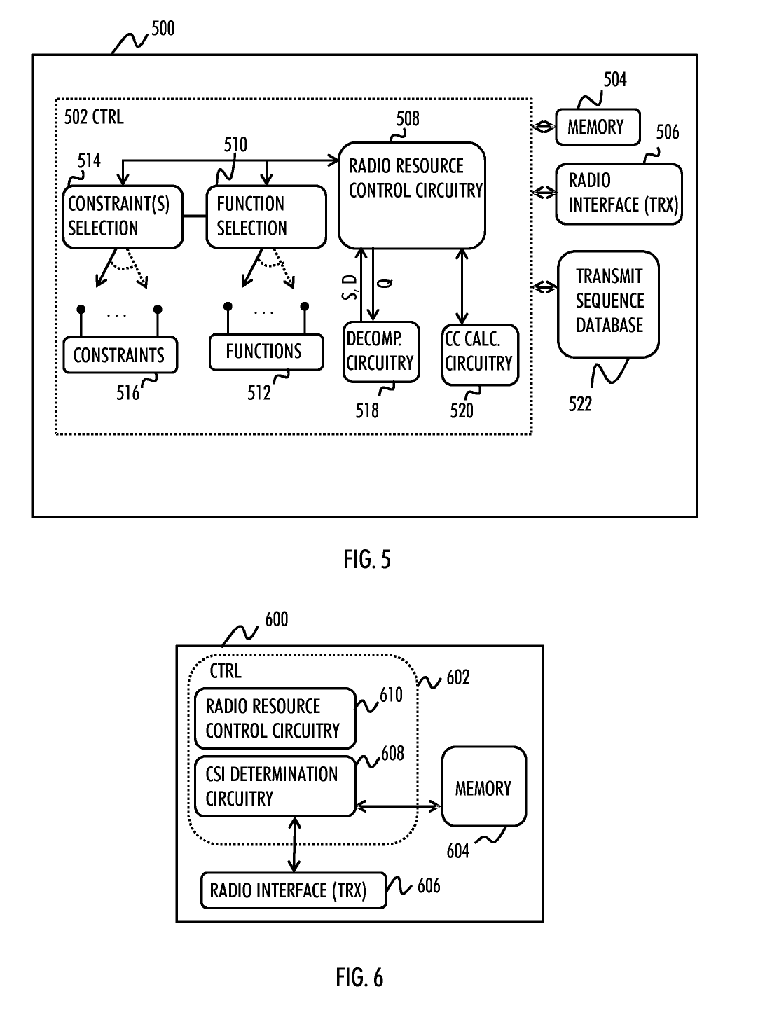

Let us take a closer look on how the joint determination in step 306 takes place by referring to FIGS. 4 to 6. FIG. 4 shows step 306 of FIG. 3 with more details. FIG. 5 shows an embodiment which provides an apparatus 500 comprising at least one processor 502 and at least one memory 504, including a computer program code, wherein the at least one memory 504 and the computer program code are configured, with the at least one processor 502 to cause the apparatus 500 to carry out at least some of the embodiments. FIG. 6 presents an embodiment which provides an apparatus 600 comprising at least one processor 602 and at least one memory 604, including a computer program code, wherein the at least one memory 604 and the computer program code are configured, with the at least one processor 602 to cause the apparatus 600 to carry out at least some of the embodiments. The at least one processor 502, 602 may be implemented with a separate digital signal processor provided with suitable software embedded on a computer readable medium, or with a separate logic circuit, such as an application specific integrated circuit (ASIC). It should be noted that FIGS. 5 and 6 show only the elements and functional entities required for understanding the apparatuses. Other components have been omitted for reasons of simplicity. The implementation of the elements and functional entities may vary from that shown in Figures. The connections shown in Figures are logical connections, and the actual physical connections may be different. The connections can be direct or indirect and there can merely be a functional relationship between components. It is apparent to a person skilled in the art that the apparatuses may also comprise other functions and structures.

The apparatus 500 may be comprised in a base station (also called a base transceiver station, a Node B, a radio network controller, or an evolved Node B, for example) of the secondary user system. Thus, the apparatus may be or be coupled to the SBS 112. The apparatus 500 may comprise a circuitry, e.g. a chip, a processor, a micro controller, or a combination of such circuitries in the base station and cause the base station to carry out the functionalities related to the embodiments. The apparatus 600 on the other hand may comprise the terminal device of the secondary user system, e.g. a computer (PC), a laptop, a tabloid computer, a cellular phone, a communicator, a smart phone, a palm computer, or any other communication apparatus. In another embodiment, the apparatus 600 is comprised in such a terminal device, e.g. the apparatus may comprise a circuitry, e.g. a chip, a processor, a micro controller, or a combination of such circuitries in the terminal device. In other words, the apparatus 600 may be or be coupled to the SU 114. Further, the apparatus 500 and/or 600 may be or comprise a module (to be attached to the UE/base station) providing connectivity, such as a plug-in unit, an “USB dongle”, or any other kind of unit.

The joint determination of the transmit coefficients S and power allocation D may comprise as shown in step 400 of FIG. 4 maximizing a function related to a transmit covariance of at least one SU 114 and to at least part of the obtained CSI such that at least power allocation across one or more of the at least one SU 114 does not exceed a predetermined power threshold. Thus, the apparatus 500 may select by a function selection unit 510 one of a predetermined functions 512 to be maximized. The CSI may be obtained at least partly by a CSI determination circuitry 608 of the apparatus 600. In addition, there may be a CSI determination unit in the apparatus 500, although not shown in FIG. 5, in order to obtain CSI of H. Thereafter, the apparatus 600 may apply radio interface components 606 in transmitting information about the determined CSI to the SBS 112 (for example, to the apparatus 500).

In an embodiment, the selection of the function by the function selection unit 510 may be constant such that a same single function is selected always. However, in another embodiment, there may be a plurality of functions in the functions database 512 and the selection of the function to be maximized may depend on the resources of the apparatus 500, on which transmit coefficients are to be determined, on whether the transmission from the SU 114 is rank one transmission or not, for example, as will become clear later. The function may comprise the transmit covariance as one variable which needs to be maximized, for example. Alternatively, the transmit covariance may be proportional to the function to be maximized, for example. The CSI of H and possibly also of G may affect the function to be maximized. For example, the function may comprise the known channel H and possibly also the known channel G. The maximization of the selected function may be subject to constraints 516. As said, the maximization may be subject to the power threshold related constraint, which limits the amount of transmit power across one or more of the at least one SU 114. However, there may be further constraints selectable by a constraints selection unit 514 in addition to the power threshold related constraint, as will become clear later.

In an embodiment, a singular value or eigenvalue decomposition may be performed in step 402 by a decomposition circuitry 518 comprised in the processor 502 of apparatus 500. The singular value or eigenvalue decomposition may be performed for the transmit covariance obtained from the maximized function in order to jointly determine the power allocation D and the transmit coefficients S. The joint determination may be performed at the SBS 112. Thereafter, the SBS 112, and more particularly, a radio resource control circuitry 508 together with a radio interface (TRX) 506, may communicate information indicating the determined power allocation D and transmit coefficients S to the at least one SU 114 via the radio interface components 506 and 606 in order to allow the at least one SU 114 to apply the determined power allocation D and transmit coefficients S in data communication, such as in transmission and/or reception of data. In the apparatus 600, the radio resource control circuitry 610 may be responsible of applying the correct transmit power allocation and transmit coefficients in the data transmission, for example. The memory 604 may be used to store the obtained information related to power allocation and transmit coefficients. To apply the determined transmit coefficients and power allocation is advantageous so that the transmission from the SU 114 is performed under predetermined parameters which take the interference to the PUs 104 and to the existence of other SUs into account. It should be noted that in some embodiment, the step 402 is omitted as the joint determination of the power allocation and the transmit coefficients is obtained without decomposing the transmit covariance.

As said, the transmit coefficients S may comprise one of the following: spatial multiplexing precoder coefficients, spatial beamforming coefficients, and spreading sequence. Let us first consider an embodiment where the determined transmit coefficients S comprise spatial multiplexing precoder coefficients to be applied in multistream transmission from the at least one SU 114 to the SBS 112. Spatial multiplexing (SMX) is a transmission technique in MIMO wireless communication in order to transmit a plurality of independent and separately encoded data signals, so-called data streams, from the transmitter comprising multiple antennas for at least transmission. Therefore, the space dimension is reused, or multiplexed, more than one time. When the transmitter is equipped with Nₜ antennas and the receiver (the secondary BS) has Nₛ antennas, the maximum spatial multiplexing order, i.e. the number of data streams N_{ds}, when linear receiver is used, may be given as

N_{ds}=min(Nₜ,Nₛ). (3)

This may denote that N_{ds} streams may be transmitted in parallel, ideally leading to an N_{ds} increase of the spectral efficiency. If the streams experience low or no correlation, the N_{ds} may be seen to be equivalent to the rank of the channel between the transmitter and the receiver.

For the case of secondary user spatial multiplexing, the transmitted signal may be written as xᵢ=Sᵢdᵢ, where Sᵢ is the spatial precoder matrix for the SU i, and dᵢ is a rᵢ×1-dimensional data vector. In other words, the precoding matrix Sᵢ may be used to precode the to-be transmitted data in the vector dᵢ to enhance the performance. The transmit signal may have a transmit ance Qᵢ=E{xᵢxᵢ^{H}} and an associated power constraint Tr(Qᵢ)≦Pᵢ, where the superscript H denotes Hermitian transpose. The transmit power constraint Pᵢ per SU i may be represented in a number of ways: as an example, you may assume dᵢ is an independent identically distributed (i.i.d.) Gaussian random vector with a diagonal covariance matrix having trace Pᵢ and the precoding matrix is normalized to unit power.

It should also be noted that, for aggregate channels, the signal models in (1) and (2) may be rewritten as

yₛ=\tilde{H}\tilde{x}+nₛ (4),

and

yₚ=Hₚxₚ+\tilde{G}\tilde{x}+nₚ (5),

where \tilde{H}=[H₁ . . . H_{K}_{ₛ}] and \tilde{x}=[x₁^{T} . . . x_{K}_{ₛ}^{T}]^{T}, wherein the superscript T denotes transpose. The aggregate channel at the PU may be defined similarly. Likewise, the aggregate transmit covariance may be defined as \tilde{Q}=E{\tilde{x}\tilde{x}^{H}}. In order to obtain transmit coefficients, such as the multiplexing precoding coefficients Sᵢ from the computed covariance Qᵢ the obtained Qᵢ or \tilde{Q} may be decomposed in a singular value or eigenvalue decomposition circuitry 518 of FIG. 5 as,

Qᵢ=Sᵢ*Dᵢ*Sᵢ^{H} (6),

in the case of standard eigenvalue decomposition, where Dᵢ is a power allocation for the data vector d. Therefore, in some embodiments, based on the EVD or SVD of Q, the required parameters S and D may be obtained.

To briefly explain the singular value decomposition (SVD) and the eigenvalue decomposition (EVD), the SVD may be used to decompose the matrix M under examination into a product of three matrices as follows M=UDV^{H}, where U and V are a unitary matrices and D is a matrix whose elements are all zero except for the diagonal which comprises the singular values of the matrix M. The columns of U and V represent singular vectors of the matrix M. The eigenvalue decomposition (EVD) on the other hand denotes a factorization of the matrix M in the form of M=ADA⁻¹, where A is a unitary matrix and D is a diagonal matrix. The columns of A may give the eigenvectors of the matrix M and the values in the diagonal of D denote corresponding eigenvalues. It should also be noted that when M is normal positive semi-definite matrix, the SVD of M equals to EVD of M. It should also be noted that for unitary matrixes A⁻¹=A^{H}. Thus, obtaining Q for at least one SU and performing eigen- or singular value decomposition to the Q may yield powers D and transmit coefficients S for the SU.

In an embodiment, the function to be maximized represents a secondary user multiple access channel (MAC) sum rate. Thus, the function selection unit 510 may select a MAC sum rate function from the functions database 512. The MAC sum rate may be given as

log₂|I+\tilde{H}\tilde{Q}\tilde{H}^{H}Z⁻¹| (7),

where Z is a covariance of an additive white Gaussian noise (AWGN) at the SBS 112. When a MIMO system is used as in the spatial multiplexing of data streams from the SU 114 to the SBS 112, a theoretical maximum capacity may be obtained by applying a generalized version of Shannon's formula, wherein the capacity is achieved by transmitting independent complex circular Gaussian symbols along the eigenvectors of Q. The powers allocated to each eigenvector are given by the eigenvalues of Q.

The MAC sum rate function, which may be a concave function, may be maximized with the aid of certain constraints 516. In an embodiment, the function is maximized such that, in addition to the power threshold related constraint, interference to the at least one primary user does not exceed a predetermined interference threshold. Thus, in an embodiment there may be at least two constraints which are used in maximizing the sum rate function (7), wherein one constraint may be related to the interference constraint to the primary user and another constraint may be related to power allocation across the SUs. The power constraint may relate to a global sum power, for example.

As said, the joint determination of S and D may be computed at the SBS 112 which may possess the CSI of all relevant SUs with respect to G and H. The SBS 112 may perform optimal joint detection of all SUs on the uplink. In an embodiment, the optimization problem of interest with MAC sum rate function subject to two constraints may be written as

max_{\tilde{Q}} log₂|I+\tilde{H}\tilde{Q}\tilde{H}^{H}Z⁻¹|

such that (s.t.) log₂|I+\tilde{G}\tilde{Q}\tilde{G}^{H}|≦Iₚ

Tr(\tilde{Q})≦Σᵢ₌₁^{K}^{_{sP}}ᵢ. (8)

In the first constraint, the mutual information or interfering capacity rate, which is leaked to the PUs (either one or many), is limited to a constant Iₚ. As an example, the power allocation to the secondary users is assumed to be arbitrary, wherein a single power threshold Pᵢ may be applicable across the at least one secondary user 1 to Kₛ, as shown in the second constraint representing the global power budget. As said, the objective function may be concave at start. However, the first constraint as such may also be concave in \tilde{Q}. Therefore, to obtain a convex optimization problem, the first constraint may be relaxed by replacing it with a Taylor series expansion about \tilde{Q}, which reads as log₂|I+\tilde{G}\tilde{Q}\tilde{G}^{H}|≈log₂|I+\tilde{G}\tilde{Q}₀\tilde{G}^{H}|+Tr((\tilde{G}\tilde{Q}₀\tilde{G}^{H}+I)⁻¹\tilde{G}(\tilde{Q}−\tilde{Q}₀)\tilde{G}^{H}), which is convex in \tilde{Q} because \tilde{Q}₀ is an appropriately chosen constant (for example, a scaled identity matrix with trace equal to global power constraint). The relaxed sum-rate maximization problem may be a convex maximization problem. As such, the problem of (8) may be solved to yield \tilde{Q}. As \tilde{Q} comprises Qᵢ for each SU i, the radio resource control circuitry 508 may derive Q for different SUs. Thereafter, the radio resource control circuitry 508 may forward each Qᵢ to the decomposition circuitry 518 which performs, for example, the eigenvalue decomposition to the Qᵢ. As a consequence, the precoding matrix Sᵢ and the power allocation Dᵢ may be obtained from the eigenvalue decomposition of Qᵢ. As shown the proposed embodiment advantageously solves transmit coefficients and power allocation jointly by taking the interfering channel G into account. The transmitting SU may not need to perform, for example, water filling which may save computational resources of the SU.

In another embodiment, the interfering rate constraint in (8), i.e. the first constraint in (8), is replaced with an interference power constraint of the form Tr(\tilde{G}\tilde{Q}\tilde{G}^{H})≦Tₚ, which is convex. Thus, the sum rate function may be solved with the aid of at least this constraint. Accordingly, no Taylor series expansion may be needed and the precoding matrix Sᵢ and the power allocation Dᵢ for each SU i may be determined from the eigenvalue decomposition of Qᵢ, which is obtained by solving the maximization problem with respect to \tilde{Q}. As seen, the interference constraint to the at least one PU may be represented by at least one of the following: a mutual information rate from the at least one SU to the at least one PU, and an interference power from the at least one SU to the at least one PU. This allows for flexibility for the solving of the optimization problem.

In yet another embodiment for obtaining transmit coefficients S for the SU multiplexing scenario, power allocation to the SUs may be assumed to be SU-specific, wherein a SU-specific power threshold is applied for each of the at least one SU. In this case, the cooperation across SUs may not be allowed and each SU transmits independent signals, i.e., arbitrary power allocation across SUs is precluded. This may indicate that \tilde{Q} is block diagonal and individual power constraints of each SU may need to be applied. Thus, in this case the sum rate maximization under these conditions may be written as

$$s . t . {max}_{Q 1 , ⋯ , {Q}_{{K}_{s}}} {log}_{2} \vert I + {H}_{i} {Q}_{i} {H}_{i}^{H} {Z}^{- 1} \vert \\ Tr ( {\sum }_{i = 1}^{{K}_{s}} {G}_{i} {Q}_{i} {G}_{i}^{H} ) \leq {T}_{p} \\ {H}_{i} {Q}_{j} {H}_{i}^{H} = 0 ∀ i , j , i \neq j \\ Tr ( {Q}_{i} ) \leq {P}_{i} , \qquad ( 9 )$$

which is a convex optimization problem over the individual SU transmit covariances Qᵢ. Thus, the precoding matrix Sᵢ and the power allocation Dᵢ for each SU i may be obtained from the eigenvalue decomposition of Qᵢ. It should be noted here that the constraint related to the transmit power towards the primary user may be replaced with the mutual information rate constraint as given in (8).

In an embodiment, the function to be maximized represents a difference of the SU MAC sum rate given in (7) and a mutual information rate from the at least one SU to the at least one PU shown as the first constraint in (8). Information-theoretically, it may represent the maximum SU sum rate that cannot be decoded by the PU. In this case, the maximization problem may be given as:

max_{\tilde{Q}} log₂|I+\tilde{H}\tilde{Q}\tilde{H}^{H}Z⁻¹|−log₂|I+\tilde{G}\tilde{Q}\tilde{G}^{H}|

s.t. Tr(\tilde{Q})≦Σᵢ₌₁^{K}^{_{sP}}ᵢ. (10)

Thus, only one constraint may be needed. In order to solve this, it may be denoted that H′=\tilde{H}Z^{-1/2}. At high SNRs, a near-optimal closed-form solution for \tilde{Q} may be obtained from a generalized singular value decomposition (GSVD) of the matrix pencil (H′,\tilde{G}). Therefore, in an embodiment, the transmit covariance may be obtained from the maximized function by applying the GSVD for a matrix pencil of a pair of propagation channel matrices comprising the propagation channel between the at least one SU and the SBS and the propagation channel between the at least one SU and the at least one PU. The GSVD jointly diagonalizes this pair of channel matrices into parallel subchannels. Interference to the PU may be minimized by allocating power only to those subchannels (i.e. data streams) which have singular values greater than one. Thus, both the power allocation and the transmit coefficients in the form of spatial multiplexing precoder may be obtained.

Let us then consider embodiments where the number of transmitted data streams from the SU i is one, i.e. the SUs perform rank-1 transmission to the SBS. This may take place by applying beamforming, for example. In beamforming the SU has several antennas and applies the antennas to direct the transmit beam appropriately so that little or no interference to the primary user is caused. In other words, beamforming is a signal processing technique used in sensor arrays for directional signal transmission or reception. This may be achieved by combining elements in the array in a way where signals at particular angles experience constructive interference and while others experience destructive interference. The desired direction may be obtained by using a phased array, where each antenna is shifted a slightly different amount in phase. In order to set appropriate weights for each antenna to ensure proper beamforming, the transmitter may apply beamforming coefficients, or a beamformer, in the form of a vector with dimensions N×1, where N is the number of transmit antennas Nₜ. In this case, the transmit coefficients may comprise the beamforming coefficients.

On the other hand, in order to transmit a single stream to the SBS, the SU need not be equipped with multiple antennas. In so called spreading technique, the transmitted signal is spread in frequency to mitigate frequency related interference to the transmitted signal. In connection with a code division multiple access (CDMA), the modulation of the data may performed twice: firstly by a spreading sequence and secondly by a carrier. In this case, the transmit coefficients may comprise the spreading sequence which is used to modulate the transmitted data vector. It should be noted that mathematically beamforming and spreading sequence optimization problems may be equivalent.

When the SUs are restricted to transmit beamforming or to employ spreading sequences, only a single data stream may be transmitted per each SU 114. This may imply that the transmit covariance may have rank=1. Therefore, in an embodiment, the MAC sum rate function may be maximized such that, in addition to at least one of the power and interference related constraints, the rank of the transmit covariance is forced to be one. In other words, rank(Qᵢ)=1, i=1, . . . , Kₛ. Thus, for example, the maximization problem presented in (8) may be further limited as

max_{\tilde{Q}} log₂|I+\tilde{H}\tilde{Q}\tilde{H}^{H}Z⁻¹|

s.t log₂|I+\tilde{G}\tilde{Q}\tilde{G}^{H}|≦Iₚ

Tr(\tilde{Q})≦Σᵢ₌₁^{K}^{_{sP}}ᵢ

Rank(Qᵢ)=1,i=1, . . . , Kₛ. (11)

However, the rank constraints may benon-convex. Therefore, in order to obtain a convex problem, a possible approach may be to introduce an approximation of the rank-1 constraint as rank(X)˜log₂|X+aI|, where a is an arbitrarily selected small number, such as a=0.01. Thus, the problem of (11) may be solved and the power allocation and the transmit coefficients may be obtained from the EVD or SVD of Q. Similarly, the additional rank-1 constraint may be added to any of the above described maximization problems to yield the transmit coefficients (a beamformer or a spreading sequence) and the power allocation for each SU i by factorizing the obtained Qᵢ or \tilde{Q} with EVD or SVD. For example, the trace of obtained Qᵢ may represent the power allocation, and the beamforming vector may be the principal eigenvector of Qᵢ. In other words, an eigenvalue decomposition of Qᵢ may be performed to obtain the beamformer.

In an embodiment, the function to be maximized may not be the sum rate function of (8), (9) or (11), but the function may be a signal-to-noise ratio (SINR) of the received signal. The SINR may be coupled to the sum rate as capacity C=log₂(1+SINR). For example, let sᵢ be the transmit beamforming vector of the SU i. It may also be assumed that the SBS 112 applies a linear receive beamformer for each SU instead of joint detection. It is to be noted that all other transmitting SUs may be considered as interference to the received signal from SU i (intra-SU interference). As a consequence, the SBS may employ an optimal minimum mean square error (MMSE) receive beamformer to detect each SU i. The post-detection SINR of SU i is then given by γᵢ=sᵢ^{H}Hᵢ^{H}Rᵢ⁻¹Hᵢsᵢ, where Rᵢ=Σ_{j=1,h≠i}^{K}^{ₛ}Hⱼsⱼsⱼ^{H}Hⱼ^{H}+Z is the interference-plus-noise covariance matrix affecting SU i. Thus, the problem may be set to obtain the beamformer sᵢ such that the SINR of SU i is maximized subject to an interference power constraint Wᵢ to the PU. This may be written as

maxₛ_{ᵢ}γyᵢ

s.t. sᵢ^{H}Gᵢ^{H}Gᵢsᵢ≦Wᵢ. (12)

The constraint shown in (12) is equivalent to the trace-based power constraint in the form of Tr(\tilde{G}\tilde{Q}\tilde{G}^{H})≦Tₚ. The choice of the PU interference constraint may thus be flexible. The problem stated in (12) may be solved for sᵢ by applying a Lagrangian function in the form of Lᵢ=sᵢ^{H}Hᵢ^{H}Rᵢ⁻¹Hᵢsᵢ+λᵢ(sᵢ^{H}Gᵢ^{H}Gᵢsᵢ−Wᵢ). The first-order condition of maximizing Lᵢ with respect to sᵢ may yield the optimal solution to be the generalized eigenvector associated with the largest generalized eigenvalue of the matrix pencil (Hᵢ^{H}Rᵢ⁻¹Hᵢ, Gᵢ^{H}Gᵢ) that meets the PU interference criterion. Therefore, in an embodiment, a generalized EVD is performed for a matrix pencil relating to the Lagrangian function of the maximized function subject to the interference constraint so that the power (eigenvalue) and the beamformer (eigenvector) may be obtained. In other words, the beamforming vector sᵢ is not restricted to be of unit norm (power). Although a single stream case has been presented by taking the beamforming as an example, the same embodiments may be applicable to the single-antenna spread-spectrum systems where interference-aware cognitive user spreading sequences, which balance secondary user performance and the interference caused to primary users, may be obtained. It is also to be noted that although a single PU case is taken as an example in some of the embodiments, the embodiments may readily be applied for a scenario with multiple PUs.

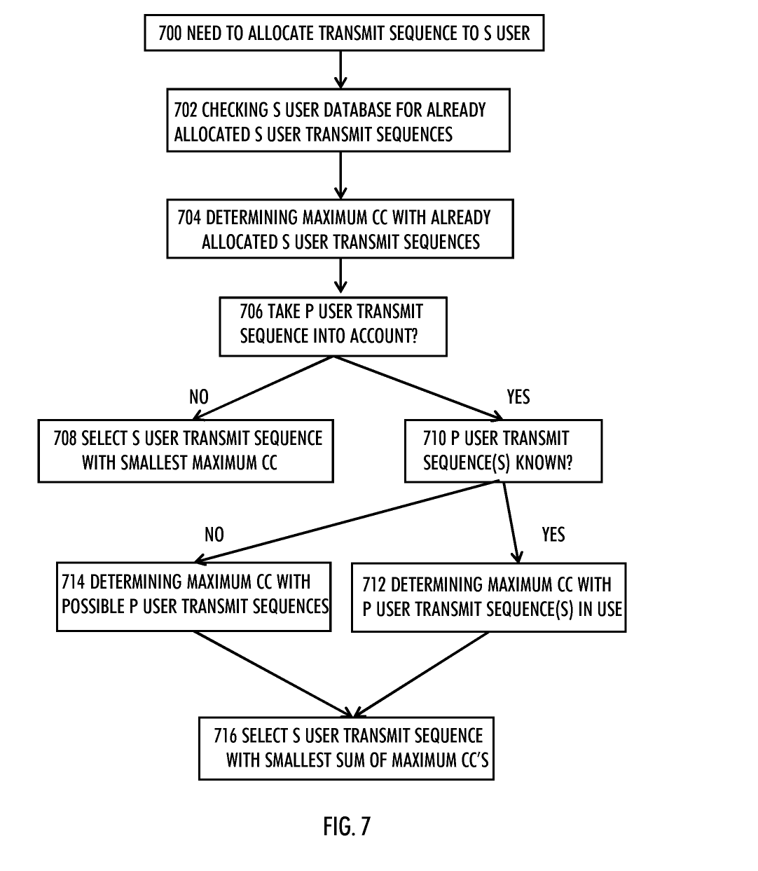

In an embodiment as shown in FIG. 7, a method for determining transmit sequence, such as beamforming coefficients or a spreading sequence, for a secondary user is presented. The embodiment takes predetermined codebooks comprising at least available transmit sequences into account. For example, in the framework of current high speed packet access (HSPA)/LTE standards, the SUs may be allocated beamformers or spreading sequences from a SU fixed codebook specific for the secondary users, while the PU takes beamformers/sequences from a PU fixed codebook specific for the primary users. The elements of the SU and PU codebooks may not be orthogonal and may have a non-zero cross-correlation (e.g. m-sequence or Gold codes in CDMA context). The SU and PU codebooks are potentially distinct, and the SBS may not have information of the beamformers being used by the PU network. It may be assumed that there are Kₛ existing SUs and a new SU enters the secondary user network and a transmit beamforming vector needs to be allocated to the new SU from the SU codebook. As the SBS allocating the beamformer may not take into account the already allocated SU and PU beamformers, the new SU may be allocated with a beamformer which may not be optimal and cause interference to the primary and secondary users, which is undesirable. At least partly in order to mitigate this scenario, it is proposed that the BS of a secondary user system utilizing shared radio communication resources with a coexisting primary user system, determines a transmit sequence to be applied by the SU in data transmission from the secondary user to the base station, wherein the transmit sequence is selected from a database, or codebook, comprising candidate secondary user transmit sequences for secondary users. The codebook may be stored in a transmit sequence database 522 of the apparatus 500, for example. The database may comprise updated information on which SU transmit sequences have been already allocated to the other SUs. Such information may have been obtained from other secondary base stations or from other secondary users. The database may also comprise updated information on which transmit sequences have been already allocated to the PUs. Such information may have been obtained from network element(s) of the primary user system.

To avoid unnecessary interference to existing communication, the selection of the transmit sequence for the (new) SU may be performed at least partly on the basis of cross correlation properties between the candidate secondary user transmit sequences and at least one of the following: at least one already allocated secondary user transmit sequences for the other at least one secondary user, and at least one of already allocated primary user transmit sequences for the at least one primary user. Such cross correlation (CC) properties may be determined by the CC calculation circuitry 520 of FIG. 5. When the SBS 112 determines a sequence which has a low correlation with the already allocated transmit sequences, the radio resource control circuitry 508 may select that transmit sequence and allocate it to the (new) SU.

FIG. 7 shows a flow diagram for selecting the transmit sequence from the databases, or codebooks. In step 700 the SBS determines a need to allocate a transmit sequence, either a beamformer or a spreading sequence, from the SU database 522 of FIG. 5. In step 702, the SBS may check the SU database 522 for already allocated SU transmit sequences. In an embodiment, as shown in step 704, the SBS may determine a first maximum cross correlation with the already allocated secondary user transmit sequences for each of the candidate secondary user transmit sequences. There may be one or more candidate transmit sequences and there may be one or more previously allocated SU transmit sequences. Therefore, the CC calculation circuitry 520 of FIG. 5 may calculate one or more cross correlation values. Then, it may select the maximum CC value for each of the candidate sequences. If it is decided in step 706 that the PU transmit sequences are not taken into account, the method proceeds to step 708 where the SBS may select the secondary user transmit sequence which provides smallest first maximum cross correlation. Thus, the SBS may allocate the new SU with the transmit sequence which has the smallest maximum cross correlation across the already allocated SU sequences. Thus, the selected transmit sequence to be allocated may be the one which causes least amount of interference to the other SUs, for example.

However, if it is decided in step 706 that the PU transmit sequences are to be taken into account, which decision may depend on traffic situation, location of PUs in the area, types of the primary and secondary user systems etc., the method may proceed to step 710. In step 710 it is determined whether or not the at least one PU transmit sequence already allocated to the existing PUs is known or not. When knowledge of the already allocated primary user transmit sequences for at least one primary user is available, the method proceeds to step 712. Such knowledge may be obtained from the primary user system, for example, and the knowledge may be stored in the memory 504 or in the database 522, for example. In step 712, the SBS may determine, for each of the candidate secondary user transmit sequences, a second maximum cross correlation with the already allocated primary user transmit sequences. Again, such cross correlation determination may be performed at the CC calculation circuitry 520 of FIG. 5.

However, when the SBS is unaware of the PU beamformer in use, the method proceeds to step 714 and the SBS operates under a worst-case assumption by computing the highest possible cross-correlation of the candidate SU beamformer and all elements in the PU transmit sequence database. In other words, when knowledge of the already allocated primary user transmit sequences is not available, the SBS may determine, for each of the candidate secondary user transmit sequences, a second maximum cross correlation with each of the primary user transmit sequences.

Thus, the SBS may now have knowledge of the first maximum cross-correlation and the second maximum cross correlation. Then, in step 716, the SBS may select the secondary user transmit sequence which provides smallest sum of first and second maximum cross correlations. However, it is to be understood that any other possible combination of the first and the second maximum cross-correlations, than the sum, may be used as the selection criterion. This embodiment may provide for small interference to the co-existing SUs as well as to the co-existing PUs. When the SUs and PUs are restricted to the selection of beamforming/spreading sequences from the predefined codebooks, then the embodiment may also addresses how to perform such selection in order to balance the multiple-access interference on the secondary uplink with the interference caused to the primary network.

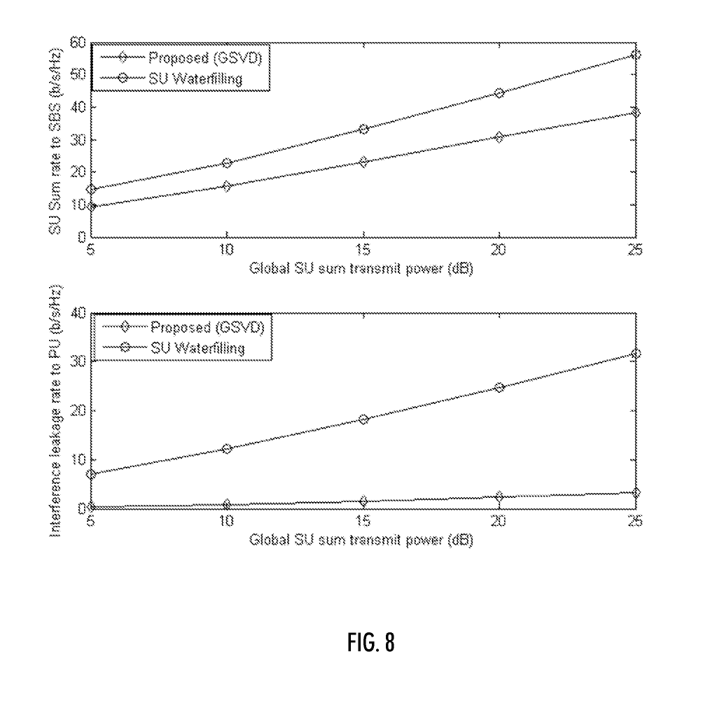

FIG. 8 shows simulation results for the proposed embodiments. In the simulations, it is assumed that there are 4 SUs each with 2 antennas, the SBS has 8 antennas, and a single PU has 4 antennas. The AWGN has unit variance, and the results are averaged over 100 Rayleigh fading channel realizations. In both graphs, the X-axis represents a global SU sum transmit power, i.e. the constraint of Equation (10), for example. The graphs compare the performances of the proposed embodiment with respect to Equation (10) and a conventional SU precoding, which applies water filling power allocation. In the upper graph MAC sum rate observed by the SBS is shown. It may be seen that the proposed scheme may achieve up to 75% of the conventional SU sum rate. However, as shown in the lower Figure, which depicts interference leakage rate to the PU, the significant advantage of the proposed embodiment may be seen to be in interference mitigation. As shown, the interference rate to the PU may be close to zero regardless of the SU transmit power in the invention, whereas the conventional method causes major interference to the PU at any transmit power. This is because the conventional method may not be interference-aware, whereas the proposed embodiments may take the interference to the SUs and to the PUs into account.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Thus, according to an embodiment, the apparatus comprises processing means configured to carry out embodiments of any of the FIGS. 1 to 7. In an embodiment, the at least one processor 502, the memory 504, and the computer program code form an embodiment of processing means for carrying out the embodiments of the invention. In another embodiment, the at least one processor 602, the memory 604, and the computer program code form an embodiment of processing means for carrying out the embodiments of the invention.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1-36. (canceled)

37. A method, comprising:
obtaining, at a base station of a secondary user system utilizing shared radio communication resources with a coexisting primary user system, channel state information with respect to both a propagation channel between at least one secondary user and the base station and a propagation channel between the at least one secondary user and at least one primary user;
jointly determining power allocation and transmit coefficients for at least one data stream which is to be transmitted from the at least one secondary user to the base station, wherein the joint determination comprises maximizing a function related to a transmit covariance of at least one secondary user and to at least part of the obtained channel state information, wherein the maximized function is subject to at least one of the following constraints: power allocation across one or more of the at least one secondary user does not exceed a predetermined power threshold, and interference to the at least one primary user does not exceed a predetermined interference threshold; and the method further comprises:
causing communication of information indicating the determined power allocation and transmit coefficients to the at least one secondary user in order to allow the at least one secondary user to apply the determined power allocation and transmit coefficients in data communication.

38. A method, comprising:
determining, at a user terminal of a secondary user system utilizing shared radio communication resources with a coexisting primary user system, channel state information with respect to a propagation channel between the secondary user and each of at least one primary user;
cause communication of information indicating the determined channel state information to a base station of the secondary user system; and
acquiring information indicating power allocation and transmit coefficients from the base station in order to apply the power allocation and transmit coefficients in data communication.

39. An apparatus, comprising:
at least one processor and at least one memory including a computer program code, wherein the at least one memory and the computer program code are configured to, with the at least one processor, cause the apparatus at least to:
obtain channel state information with respect to both a propagation channel between at least one secondary user and a base station and a propagation channel between the at least one secondary user and at least one primary user, wherein the base station is a base station of a secondary user system utilizing shared radio communication resources with a coexisting primary user system;
jointly determine, in the base station, power allocation and transmit coefficients for at least one data stream which is to be transmitted from the at least one secondary user to the base station, wherein the joint determination comprises maximizing a function related to a transmit covariance of at least one secondary user and to at least part of the obtained channel state information, wherein the maximized function is subject to at least one of the following constraints: power allocation across one or more of the at least one secondary user does not exceed a predetermined power threshold, and interference to the at least one primary user does not exceed a predetermined interference threshold; and the apparatus is further caused to:
cause communication of information indicating the determined power allocation and transmit coefficients to the at least one secondary user in order to allow the at least one secondary user to apply the determined power allocation and transmit coefficients in data communication.

40. The apparatus of claim 39, wherein the apparatus is further caused to:
perform a singular value or an eigenvalue decomposition of the transmit covariance obtained from the maximized function in order to jointly determine the power allocation and the transmit coefficients.

41. The apparatus of claim 39, wherein the function to be maximized represents a secondary user multiple access channel sum rate.

42. The apparatus of claim 39, wherein the apparatus is further caused to:
maximize the function such that power allocation across one or more of the at least one secondary user does not exceed a predetermined power threshold and the interference to the at least one primary user does not exceed a predetermined interference threshold.

43. The apparatus of claim 39, wherein the function to be maximized takes into account a mutual information rate from the at least one secondary user to the at least one primary user.

44. The apparatus of claim 43, wherein the apparatus is further caused to:
obtain the transmit covariance from the maximized function by performing a generalized singular value decomposition to a matrix pencil of a pair of propagation channel matrices comprising the propagation channel between the at least one secondary user and the base station and the propagation channel between the at least one secondary user and the at least one primary user; and
minimize interference to the at least one primary user by allocating power to only those data streams which have singular values greater than one.

45. The apparatus of claim 39, wherein the determined transmit coefficients comprise spatial multiplexing precoder coefficients to be applied in multistream transmission from the at least one secondary user to the base station.

46. The apparatus of claim 39, wherein the apparatus is further caused to:
maximize the function such that, in addition to at least one of the power and interference related constraints, the rank of the transmit covariance is forced to be one, wherein the determined transmit coefficients comprise either the spatial beamforming coefficients or the spreading sequence to be applied in rank one transmission from the at least one secondary user to the base station.

47. The apparatus of claim 39, wherein the function to be maximized represents a signal-to-noise ratio of a received secondary user signal at the base station, and the apparatus is further caused to:
perform a generalized eigenvalue decomposition for a matrix pencil relating to the Lagrangian function of the maximized function in order to jointly obtain the transmit coefficients and the power allocation, wherein the maximized function is subject to the interference power constraint such that interference to the at least one primary user does not exceed a predetermined interference threshold, and wherein the determined transmit coefficients comprise either the spatial beamforming coefficients or the spreading sequence to be applied in rank one transmission from the at least one secondary user to the base station.

48. The apparatus of claim 39, wherein the interference to the at least one primary user is represented by at least one of the following: a mutual information rate from the at least one secondary user to the at least one primary user, and an interference power from the at least one secondary user to the at least one primary user.

49. The apparatus of claim 39, wherein the power allocation to the secondary users is assumed to be arbitrary, wherein a single power threshold is applicable across the at least one secondary user.

50. The apparatus of claim 39, wherein the power allocation to the secondary users is assumed to be secondary user-specific, wherein a secondary user-specific power threshold is applied for each of the at least one secondary user.

51. An apparatus, comprising:
at least one processor and at least one memory including a computer program code, wherein the at least one memory and the computer program code are configured to, with the at least one processor, cause the apparatus at least to:
determine channel state information in a user terminal of a secondary user system utilizing shared radio communication resources with a coexisting primary user system, wherein the channel state information is with respect to a propagation channel between a secondary user and each of at least one primary user;
cause communication of information indicating the determined channel state information to a base station of the secondary user system; and
acquire information indicating power allocation and transmit coefficients from the base station in order to apply the power allocation and transmit coefficients in data communication.

52. The apparatus of claim 51, wherein the apparatus is further caused to:
estimate an incoming channel from each of the at least one primary user;
apply reciprocity assumption in order to derive the channel from the secondary user to each at least one primary user.

53. The apparatus of claim 51, wherein the apparatus is further caused to:
determine channel state information with respect to a propagation channel between the secondary user and the base station of the secondary user system.

54. The apparatus of claim 51, wherein the transmit coefficients comprises one of the following: spatial multiplexing precoder coefficients to be applied in multistream transmission from the at least one secondary user to the base station, spatial beamforming coefficients to be applied in rank one transmission from the at least one secondary user to the base station, and spreading sequence to be applied in rank one transmission from the at least one secondary user to the base station.

55. The apparatus of claim 51, wherein the received power allocation and transmit coefficients jointly maximize a function related to a transmit covariance of the secondary user and to at least part of the communicated channel state information.

56. A computer program product embodied on a distribution medium readable by a computer and comprising program instructions which, when loaded into an apparatus, execute the method according to claim 37.

57. A computer program product embodied on a distribution medium readable by a computer and comprising program instructions which, when loaded into an apparatus, execute the method according to claim 38.
